(19) United States
(12) Patent Application Publication
(10) Pub. No.: US 2019/0308153 A1
(43) Pub. Date: Oct. 10, 2019

(54) FUEL PRODUCTION SYSTEM FOR POWER PLANTS

(71) Applicant: Peter P. SMOLKA, Munster (DE)

(72) Inventor: Peter P. SMOLKA, Munster (DE)

(21) Appl. No.: 16/336,356

(22) PCT Filed: Sep. 25, 2016
(86) PCT No.: PCT/EP2016/025103

§ 371 Date: Jun. 12, 2019

(51) Int. Cl. B01J 8/02; C10G 2/00; C01B 3/16; C01B 32/40; C01B 3/10

(52) U.S. Cl. CPC B01J 8/0278; C10G 2/34; B01J 8/0285; C01B 3/16; C01B 32/40; C01B 3/105; C01B 2203/1264; B01J 2208/00106; C01B 2203/0283; C01B 2203/061; C01B 2203/0883; C01B 2203/0833; C10G 2300/1022

(57) ABSTRACT

The invention relates to a method for producing carbon-containing products selected from the group comprising or consisting of gasoline, diesel, kerosene and methane from the steam upstream or downstream of a steam turbine or from geothermally derived steam, characterized in that, at temperatures above 400° C., the carbon-containing products are obtained exclusively or predominantly from the steam and from carbon dioxide (CO2).

The invention further relates to a fuel production system suitable for obtaining carbon-containing products selected from the group comprising or consisting of gasoline, diesel, kerosene and methane from the steam upstream or downstream of a steam turbine or from geothermally derived steam, characterized in that the system is designed to carry out the aforementioned method.

Until now, in the case of many power types, in particular in power stations with heat generation based on fossil fuels (such as, for example, in carbon-, oil-and gas-fired power stations), as well as in nuclear power stations and geothermal power stations and other the problem that it (a) waste heat, and (b) except for geothermal energy and nuclear power stations, that is to say in particular in power stations with heat generation, which is based on fossil fuels is produced, carbon dioxide (CO₂) as waste material. Furthermore, in the exhaust gas due to an incomplete combustion of the fossil fuel, if appropriate, hydrocarbons as waste material contained in the exhaust gas. Also as a power plant types in the sense of the invention can also with fossil fuels powered motors (for example marine engines) are considered to be, in which fossil fuel only for part for the purpose of generating heat energy is burned.

In order to allow for the influence of the waste heat to the environment to reduce, are in power stations often cooling towers and/or direct cooling, for example with the aid of heat exchangers and cooling by sea water, in particular when the power station is situated close to the seashore (for example occurred cooling by sea water into the nuclear power stations in Brunsbüttel and in Fukushima). In the inland are preferably cooling towers used, which, however, often an issue of citizens protests. Likewise, the emission of carbon dioxide in the power plant types with heat generation based on fossil fuels of disadvantage and reusable object from citizens protests.

The method to obtain “gasoline and diesel from CO2 of the air” is state of the art (see also Az. DE 10 2009 014 728 A1; Fischer-Tropsch synthesis, etc). The cost-effective (1) reduction of CO₂ to CO was hitherto the problem, since for this purpose, hydrogen electrolytically had to be obtained. The invention does not use any (!) of electrolysis, at least not “mainly”.

The cooling question exists in geo-thermal power plants, see DE 10 2010 004 609.4 and DE 10 2011 113 094.6, DE 10 2013 017 050. Often operate old coal-fired power stations on the economy boundary or are shut down for economic reasons.

The object of the invention is a method for producing carbon-containing products selected from the group comprising or consisting of gasoline, diesel, kerosene and methane, preferably of hydrocarbons, from the steam in front of or behind a steam turbine or from geothermal obtained steam, characterized in that

at temperatures above 300° C., preferably above 400° C.,

particularly preferably at temperatures of 450° C. to 900° C.

the carbon-containing products are obtained exclusively or predominantly from the steam, from carbon dioxide (CO₂), preferably in the air carbon dioxide contained in and/or from the the exhaust gas of an exclusively or predominantly fossil fuel-operated device.

Surprisingly it was found that according to the method of the invention, CO₂, in particular CO₂ that is generated from power stations with heat generation based on fossil fuels, together with hot water vapour (“hot steam”), in particular steam, of the “heat” in power stations, can be processed, according to the method of the patent document cost-effective to carbon-containing products, and this high-quality carbon-containing products (gasoline, diesel, kerosene and other) improve the CO₂ balance of old coal-fired power stations significantly (up to zero CO₂ emissions). If the hydrogen is available cost-effective (“for free”), the problem of the conversion of CO₂ and CO to diesel, petrol, etc. is solved.

### Sources for the Carbon Dioxide

The used carbon dioxide can be carbon dioxide in commercial purity but any gaseous mixtures, that contain carbon dioxide can be used in the method of the invention. Preferably, carbon dioxide in the sense of the invention can be used in particular from one or more of the following sources:

(i) As a source for the carbon dioxide in the sense of the invention, the air in the earth's atmosphere can be used, because the air of our earth atmosphere contains for the method according to the invention a sufficient amount of carbon dioxide. According to the invention, the atmosphere can also be considered as an intermediate storage for CO₂, because the CO₂ forms from hydrocarbons, that are used for the combustion of hydrocarbons (for example in the internal combustion engines of motor vehicles, cars, ships or in the engines of aircraft). If, in this case, hydrocarbons are used for the method of the invention which were obtained according to the method of the invention, oil as (fossil) source for the combustion is saved. Since with the aid of the method of the invention, in particular by the use of geothermal steam, can hydrocarbons from the carbon dioxide of the air (as the diffuse CO₂ source) be obtained back; in this way, the atmosphere can be considered as intermediate storage for CO₂.

A further advantage of the invention is therefore that, in use of the method of the invention, the carbon dioxide is partially removed from the atmosphere, whereby the further increase of the carbon dioxide content of the atmosphere is slowed or through widespread use of the method of the invention, if appropriate, even can reduced. This has then also the advantage, that the oceans do not receive more carbon dioxide and in respect to their acid content do not acidify any further, i. E. the pH value of the oceans does not reduce further.

(ii) As a source for the carbon dioxide can the exhaust gas of a device that is exclusively or predominantly operated with fossil fuels be used (such as, for example, coal, oil, gas)-operated device, preferably the exhaust gas of a fossil fuel (such as, for example, coal, oil, gas)-operated power station, or the exhaust gas from fossil fuel-driven engines (for example marine engines, the engines of motor vehicles) can be used. This waste gas contains with respect to the atmosphere a higher content of CO₂.

(iii) As a source for the carbon dioxide in the sense of the invention also carbon dioxide that has been obtained, via an air separation plant and/or extraction installations can be used. Air separation units and the extraction of CO2 from the air is known to those skilled in the art, and air extraction systems are regularly mentioned in relation to gas-and-steam turbine (GuD) and steam-power stations, for example in order to ensure optimum gas composition (for example Az DE 39 26 964 column 2, line 32).

(iv) As a source for the carbon dioxide in the sense of the invention carbon dioxide from volcanoes can be used. Is in the process of the invention, the CO2 is used in a “highly concentrated form” (in comparison to the CO2 of the air) then the inventive method of the invention is even more economical. Therefore, according to the method of the invention, as a source for the carbon dioxide the exhaust gas of an exclusively or predominantly fossil fuel-operated device, and/or carbon dioxide that is derived by means of extraction installations is used.

State of the art are methods to generate with the aid of high-temperature electrolysis hydrocarbons, so to speak, as a sub-step for storing wind electricity (power to liquids, ptl). These projects are used to store wind and solar energy in the form of hydrocarbons. The high costs are, naturally the energy costs. These projects, in analogy to the coal hydrogenation that exists since more than fifty years, split initially water steam at very high temperatures, for example 850° C., into hydrogen and oxygen electrolytically (sunfire.de). Subsequently, with the hydrogen, likewise at suitable temperature, the CO₂ to CO is reduced and then further to (if desired) “synthesized” to hydrocarbons. According to this method is, naturally, the electrical energy that is required for the high-temperature electrolysis (“wind electricity to be purchased”) a considerable cost factor.

There are a various approaches (patent documents, disclosure documents, for example DE 39 26 964 A1, Siemens or EP 2 491 998 A1, Sunfire), to process the CO₂ and CO into useful substances. These use in a first step electrolysis for hydrogen generation using, e. g. Sunfire. The electrolytic step is however expensive. Sunfire uses electrolysis at high temperatures, in order to achieve a higher reaction rate.

### Method Guide

The reaction rates of the method according to the invention are highly temperature-dependent. It is regarded as a directional value: the higher the temperature the higher the yield of carbon-containing products selected from the group comprising or consisting of gasoline, diesel, kerosene and methane, preferably of hydrocarbons. The method of the invention is characterized in that at temperatures above 300° C., preferably above 400° C., particularly preferably at temperatures of 450° C. to 850° C., the carbon-containing products are obtained exclusively or predominantly of the steam and the carbon dioxide (CO₂).

The high temperatures are available in the method of the invention very cost-effectively, since hitherto unused energy (waste heat from power stations based on fossil fuels, geo-thermal energy from the earth's interior, waste heat in nuclear power stations) is used and, according to the method of the invention, converted into high-priced carbon-containing products. In a preferred embodiment of the invention the process of the invention is characterized thereby, that at temperatures above 300° C., preferably above 400° C., particularly preferably at temperatures of 450° C. to 900° C., the water steam is first split into hydrogen and oxygen (at least partially) whereby the split is carried out in the presence of metals. This way, in the process of the invention, the hydrogen, even in large industrial quantities is produced in a very cost-effective manner, since, known from the prior art, expensive electrolysis is not required, but can optionally be combined with the method of the invention. Preferably, the method of the invention operates without electrochemical generation of hydrogen.

The invention relates to numerous metals/alloys/substances, in which at high temperature water steam splits into hydrogen and other substances. The metals are preferably selected from the group comprising or consisting of zirconium, iron, palladium, rhodium and platinum including mixtures or alloys of these metals. For example, even the material of nuclear fuel rods (but without the uranium and/or plutonium) and zircalloy-alloy are used. Under zirclloy in the sense of the invention alloys be understood of zirconium with other metals, which has more than 90% of zirconium. As further alloy components contains the zircalloy-alloy, preferably small amounts of tin (particularly preferably about 1.5%) and further metals such as iron, nickel, chromium and/or niobium. In general relates this invention also to all suitable metals, alloys and substances, in which steam at high temperatures splits into hydrogen and oxygen.

In general the invention relates to all conceivable geometries of these metals, particularly suitable are rods, grids, porous media. It could, for example, in the laboratory and industrial scale be shown that hydrogen formed at about 800° C. from water vapour (steam) in the presence of zirconium, wherein zirconium was oxidized to zirconium oxide (in particular ZrO₂).

During the nuclear accident in Fukushima, 2011, the jackets of the fuel rods have been damaged at about 800° C. The hot water steam reacted with the zirconium-containing alloy of the fuel rods to hydrogen. The quantities of formed hydrogen had been so large that the hydrogen had to be discharged.

### Cyclic Process

The metal, which is used for splitting steam into hydrogen and oxygen can after the reaction be present in oxidized form. In a particularly preferred embodiment of the invention, the method of the invention is therefore characterized in that the metal, which is used in the step of splitting steam into hydrogen and oxygen, and after the reaction is appears in oxidised form, is reduced again (recycled) in the process according to the invention and used again in the step of splitting of steam into hydrogen and oxygen (“cyclic process”). Said cyclic process has the advantage that the procedure is economical. The reduction of the oxidised metals can be carried out according to known to those skilled in the art method. For example the reduction of the metal oxides can take place with the aid of carbon. Also being possible, such as, for example, in the case of ZrO₂, that first ZrCl₄ is generated which then is reduced. From the state of the art is, for example, known (source: zirconium: https://de.wikipedia.org/wiki/zirconium?Oldid=148356524 authors: Chd, Brion VIBBER et al.), that zirconium as most frequent zirconium-raw material is, before further processing converted into zirconium dioxide. For this purpose, the zirconium is cooked in a sodium hydroxide melt (alkaline digestion). The zirconium dioxide is then with coke processed in the electrical arc to zirconium carbonitride (carbon and nitrogen-containing zirconium) and then converted with chlorine to zirconium tetrachloride.

ZrO₂+2C+2C₁₂ at 900° C.→ZrOC₁₄+2CO

A direct reduction of zirconium dioxide with carbon (such as in a blast furnace process) is impossible, since it is very difficult to separate the resulting carbides from the metal. Instead is zirconium tetrachloride is reduced in the so-called kroll process with magnesium in a helium atmosphere to zirconium metal.

ZrCl₄+2Mg→Zr+2MgCl₂″

In addition it is in the sense of the invention, when metal compounds are used, from which in the course of the method of the invention, the metals form. Thus, according to the method of the invention metal oxides or metal salts are used, because from these when passing through the reduction step of the circular process, the metal is generated, which then, is used for the split of the steam into hydrogen and oxygen. Metal oxides are to be understood as the oxides of said metals. The metal salts are to be understood as the halides, sulfates, hydroxides of the aforementioned metals.

Advantageous for the economic efficiency is that the energy for these circular process is “for free”, for example, but not only from the hot exhaust gas of the chimneys, geothermal energy or the hot steam of a power plant (for example the hot steam behind the steam turbine of a power plant). Main intention of this process is to transform cost-effective energy (hot exhaust gas of the chimneys, geo-thermal energy or the hot steam of a power plant) into a high-priced product (carbon-containing products selected from the group comprising or consisting of gasoline, diesel, kerosene and methane, preferably of hydrocarbons). A further advantage of the method of the invention is the saving of CO₂.

The high temperatures are in the method of the invention available very cost-effective de facto “for free”. The individual steps, for example, metal treatment, which without doubt cost energy, are driven by the “cost free” energy.

The metal preparation can, for example, operate as a containerised system, preferably driven by the heat of the chimneys of power stations, volcanoes, geothermal sites. Intention is to convert “cost free” but hitherto unused energy (in the chimneys, from the earth's interior (geothermal), waste heat in nuclear power stations) into “high priced products” (gasoline, diesel, etc). Advantageous for the efficiency in the case of a geo-thermal energy source: the cooling is reduced through omitting it through converting the steam, together with the CO₂ from the air to carbon-containing products selected from the group comprising or consisting of gasoline, diesel, kerosene and methane, preferably of hydrocarbons.

The method of the invention is a fuel production device that produces carbon-containing products selected from the group comprising or consisting of gasoline, diesel, kerosene and methane, preferably of hydrocarbons from the steam before or after a steam turbine characterized in that at temperatures above 300° C., preferably above 400° C., particularly preferably at temperatures of 450° C. to 850° C., the carbon-containing products are obtained exclusively or predominantly from the steam and the carbon dioxide (that is the CO₂ from the air, from the exhaust gas of a device that is exclusively or predominantly operated with fossil fuels or with CO₂ that is obtained from extraction devices). The wording “before or after the steam turbine” implies that the steam is either used before flowing through the steam turbine (“before the steam turbine”) or after flowing through the steam turbine according to the method of the invention (“after the steam turbine”). Under steam in the sense of the invention water steam is understood.

In a particularly preferred embodiment of the invention, the fuel production device is adjusted such that the steam is first split into hydrogen and oxygen with the split occurring in the presence of metals and, that the metal, which is used in the step of splitting steam into hydrogen and oxygen, and after the reaction is appears in oxidised form, is reduced again (recycled) and used again in the step of splitting of steam into hydrogen and oxygen (“cyclic process”).

In a further preferred embodiment of the invention the fuel production system is designed in such a way, that the installation comprises a heat pump and/or a heat exchanger, particularly preferably a heat pump that

a) entirely or predominantly is used as an auxiliary device for cooling and/or heating of the steam and/or

b) is used for heating of the carbon dioxide high, preferably the CO₂-containing exhaust gas.

For example in case of geothermal power plants the steam, which is generated with a well and H₂O that flows into the well (for example the steam behind an turbine of an electricity-generator) can be brought with a heat pump (preferably with a high-temperature heat pump), which uses hot water steam as gas to be compressed/expanded, can be brought to a temperature that is suitable for the invention. For example the steam can first be brought with a heat pump to a temperature of ca. 450° C., and then can the temperature be increased stepwise to 850° C. The larger quantity steam flows, cooled from the heat pump, back into the well. The smaller quantity is converted with the method of the invention to, carbon-containing product

selected from the group comprising or consisting of gasoline, diesel, kerosene and methane, preferably hydrocarbons.

In the method of the invention the heat pump serves for
a) fully or partially for cooling and/or heating of the used steam and/or
b) for heating carbon dioxide high, preferably from CO2-containing exhaust gas.

The claims refer to installations that bring the steam fully or partially behind a steam turbine through heat pumps, heat exchangers or other suitable devices to a higher temperature level (“heat high”). The steam of the cooled side flows, in case of geothermal power stations, possibly through several steps, back into the well. In case usage of steam from a power plant the steam flows into the process of the power plant. The steam with the higher temperature level (the “hot side”) is, possibly in several steps, converted to carbon-containing products.

The profitability of a geothermal power plant increases clearly through (a) omitting cooling devices and, through (b) carbon-containing product

selected from the group comprising or consisting of gasoline, diesel, kerosene and methane, preferably hydrocarbons.

In case of very hot geothermal hot steam first according to the method of the invention, carbon-containing product

selected from the group comprising or consisting of gasoline, diesel, kerosene and methane, preferably hydrocarbons are produced and then for the “cooling” the steam for the turbine is generated from cold water.

In order to make the generated carbon-containing product vending-capable it must be cooled: this is done, stepwise, partly “passive” (heat exchanger), partly “active” by heat pumps, which transfer the “extracted energy ” on the one side to the “ to-be-heated side” for heating the hot steam.

Heat pumps require about 25% of the energy which they transfer, for operation. In view of the price of diesel, petrol, etc (7-10 euro/ton potable water to 200-400 USD/ton diesel) this is economical.

Source for the carbon dioxide can be the exhaust gas of an installation that is exclusively or predominantly operated with fossil fuels (such as, for example, coal, oil, gas) operated device, preferably power plant, or the exhaust gas from fossil fuel powered motors (for example marine engines, the engines of motor vehicles). This waste gas contains with respect to the atmosphere a higher content of CO₂.

To power plants which are operated exclusively or predominantly with fossil fuels (such as, for example, coal, oil, gas), especially to gas-and-steam turbine power plants, oil and coal-fired power stations, particularly preferably coal-fired power stations, applies:

1) The CO₂, there is “concentrated” in the exhaust gas of the fossil fuel-operated (such as, for example, coal, oil, gas) power station, since the exhaust gas contains, with respect to the atmosphere, a higher content of CO₂.

2) The exhaust gas itself is very hot (often 1800 to 2500° C., even “only” 900° C. are a good value).

3) Advantageously the steam of the power plant can be used for generating electricity with the aid of a steam turbine, and said steam can then be further used with the method according to the invention (“steam downstream of the turbine”).

4) Optionally the steam is, if appropriate, by heat pumps, preferably by high temperature heat pumps, transferred onto the, for the method of the invention, required temperature example, of above 300° C., preferably above 400° C., particularly preferably from 450° C. to 900° C.

The method according to the invention thus has the advantage of, that the recovery of carbon-containing products selected from the group comprising or consisting of gasoline, diesel, kerosene and methane, preferably of hydrocarbons is very economically. A further advantage is that power plants which operate exclusively or predominantly with fossil fuels (such as, for example, coal, oil, gas) can be improved, in their CO₂ balance.

Likewise, the waste heat from nuclear power stations, that is to say in particular the hot steam, that is generated there, is in the process of the invention, here also preferably in such a way that a heat pump

a) completely or predominantly for cooling and/or heating of steam according to the method and/or

b) for the high-heating of the inserted carbon dioxide, preferably of the CO₂-containing exhaust gas, is used.

[English translation, meaning CO₂ from the air or captured exhaust gas from other sources]

In case of geothermal power plants, for example above numbers, is further is to take into account, that there, for cooling the steam, until now the steam is often used for heating buildings (“house heating”) is used. If geothermal power plants are installed in remote areas, there are there only a few buildings, which can be heated. Then is the cooling of the steam (on the above-mentioned “cold” side) for the high-heating of the “small amount” with the aid of heat pumps and/or heat exchanger and producing carbon-containing products according to the method of the invention, the most economical method for cooling, in particular because carbon-containing products selected from the group comprising or consisting of gasoline, diesel, kerosene and methane, preferably of hydrocarbons are “high priced products”.

A geothermal power plant in the sense of the invention, for example, uses with the aid of a borehole of the heat in the earth's interior. A geothermal power plant in the sense of the invention can use other possibilities, such as, for example, the use of the heat from magma in magma-chambers, lava lakes, volcanoes (for example Krafla in Iceland) as energy source for the generation of hot steam. In the case of the geothermal energy, sites that are known to person skilled in the art, such as in Iceland as well as elsewhere, for example large parts of the mid ocean ridges, in which very high temperatures occur comparatively “close to the surface” (in a few kilometres depth below the sea bottom) can be used. Similarly, possible sources are:

Many volcanic islands in the Pacific ocean, such as, for example, Hawaii, and sources of high temperatures of, for example, 600-900° C. or more in great depths in Germany, Europe and wide parts of the world that are accessible for example, cheaply, with a cutting process of the inventor.

The method of the invention can also be used for the production of carbon-nitrogen-containing products from the steam in front of or behind a steam turbine or from geothermal steam obtained, characterized in that at temperatures above 400° C. the carbon nitrogen-containing products are obtained exclusively or predominantly from the steam, nitrogen oxides, and the carbon dioxide (CO₂) of the air and/or the CO₂ of the exhaust gas of an exclusively or predominantly fossil fuel-operated device. Said carbon-nitrogen-containing products can be in the form of a fertilizer or serve for the production of fertilizer.

The invention further relates to the innovative integration of existing components: this occupies the feasibility.

The decommissioning of old coal-fired power stations for economic reasons (instead increasing the profitability of the sale of gasoline and diesel made from the exhaust) shows that the invention was for professionals in the power station industry under no circumstances obvious.

Likewise, it was not obvious to use, geothermal wells for the production of gasoline and diesel. In case of high-temperature applications, in particular in the combination-heating up of the steam by cooling the “other” part, for example, but not only, in order to avoid the cooling towers, and

to increase the efficiency of coal-fired power stations (and more) this is new.

Advantageous for the profitability of the method according to the invention is, that the energy is cheap, in the ideal case, even “ for free”, that the energy occurs as a waste product in the power plants or occurs as geothermal hot steam. According to the invention the quantity of consumables and thus the costs-is very small, since the materials are re-used (Zr, other metals, alloys, substances etc.).

Conceptually the method according to the invention is a power to liquids (ptl) method, wherein the energy (“power”) is the “for free” raw material and the water price (generally purchased potable water) is very low, even (almost) “ for free”, for example in ships (desalination of sea water by the energy and purchased potable water that is brought to the site in the vessel).

Since the metal (applies meaning for alloys, other substances) Is not consumed but always “recycled”, there are no costs for consumables. Even with zirconium the method of the invention is very economical. An advantage of the invention is, finally, that the energy for driving the metal processing etc is “already present” (very cheap or “for free”), e. g. in chimneys of power stations, volcanoes, hot/deep geothermal sites, etc.

The large drillships (and many platforms) of the exploration industry can be further used as production ships. In the case of large drilling ships (state of the art) such “additional applications” are described already in the information for advertising, for example with the words “work on the sea bottom” (by means of dive robots etc). It is also possible, to use modified, such as dynamically positioned large tankers which is, for example, a particularly favourable to use a cutting process of the author to use the heat of the mid ocean ridges profitably to produce the heat and sell it as fuel. Disclosure specification DE 39 26 964 A1 uses (p. 7, left column, center) first also expensive electrolysis to make hydrogen.

EP 2 491 998 A1, Sunfire uses expensive electrolysis to produce hydrogen; mainly for storing wind electricity. Said hydrogen is used for the reduction of the carbon dioxide to carbon monoxide, wherein the carbon monoxide is further processed with hydrogen in a Fischer-Tropsch synthesis to synthetic fuels.

The Fischer-Tropsch synthesis is since the 1920-years state of the art.

In case of coal-fired power stations the power generation is thus the “preparation of the product preparation”: “producing heat”, “hydrogen and CO₂” for “diesel, gasoline, kerosene, etc” as “high priced products” from the “waste heat”.

Finally, the electricity-generation in coal-fired power stations is that cost lowering (!) step for coal hydrogenation, which nobody saw in the 1920- and 1930-years, as well as today for the production of diesel, gasoline, kerosene.

The coal (in case of coal-fired power stations) is thus “hydrogenated”, through burning it first for power generation, for generating heat, hot (!) CO₂ (gaseous) and hot (!) water vapour.

For other power plants (gas, oil, etc) this applies accordingly.

In case of geothermal energy, the heat from the earth's interior is used.

In particular in case of geothermal power stations the water steam (as a rule but not only) is brought by high temperature heat pumps to, for example, 600° C. to 800° C.-1000° C.

Higher natural steam temperatures are realistically.

Heat pumps are compressors.

As heat-transmission means water steam can be used.

The product cooling can be carried out by heat exchanger/heat pumps too.

The steam turbine is then located (advantageously but not necessarily) behind the product generation as part of the product cooling (preheating of the purchased potable water to, for example, 230° C. for driving the turbine).

Driving agent is not (!) the energy balance (energy content of the fuel in relation to the energy content of the coal used and the energy expenditure required for metal treatment).

The economic efficiency of the method of the invention is based on the following cost-relation:

1) Cost covering: fossil fuels (such as coal, oil, gas) are burned for electricity-generation anyway.

2) Profit-making: in addition, the high-priced products (carbon-containing products selected from the group comprising or consisting of gasoline, diesel, kerosene and methane, preferably hydrocarbons) from the “waste products” hot CO₂ and hot water steam are generated.

In the geothermal energy applies this meaning as well.

Here, there even the CO₂ is “for free”, for example by an air separation plant from the air or from the gas of the volcanoes.

The components themselves exist all:

(a) power stations.

(b) device for hydrogen-generating (see above) through metals/alloys/substances (nuclear accident in Fukushima as spectacular example).

(c) apparatus for metal processing.

(d) as chemical reactors those are suitable, which are used for the synthesis of gasoline/diesel, etc from CO₂-hydrogen mixtures (of the above-cited state of the art).

The invention resulted from the integration of existing components in an innovative manner.

Geothermal sites (also volcanoes) can also be operated as pure diesel/gasoline, etc-sites, for example without power plant: the CO₂ comes then, for example, by means of an air separation plant from the air.

This makes sense, for example, even in case of large-tankers, that are dynamically positioned over mid ocean ridges (generally in the crest region): there is a great heat comparatively close to the surface (a few kilometres below the seabed).

The gain for the environment:

The CO₂ of the coal is then, via fuel, emitted from vehicles.

The coal-fired power stations run CO₂-reduced (ca. 30%) or CO₂-free.

As a result crude oil is saved.

In case of geothermal energy CO₂ emissions are completely omitted.

Geothermal sites are “heat deposits”, chimneys of power stations are cost-effective heat deposits too.

The “for free” waste heat in the chimneys, through the method of the invention, is transferred into a “high priced product”.

If the product is cooled via high-temperature heat pumps, the yield of product (diesel, gasoline) is comparatively high.

Water that is used and sold in the form of a diesel/gasoline, etc must be replaced.

From the relation: “price of a ton of potable water” to “price of a ton of diesel” results the profitability.

Since the hydrogen-generating substance (metal/alloy/material) is always “reprocessed”, this is achieved as a circular process (“catalytically”).

Since the energy for that is “for free” (hot exhaust gas), the method is very economical.

Focus is not (!) put to the kJ (as in other patents, etc, eg Az. DE 10 2009 014 728 A1).

Preferred embodiment of the invention: in the hot exhaust gas (CO₂) and the hot steam (water vapour) metal is positioned such that hot exhaust gas flows around it, for example in the form of rods, grids, porous materials, wherein hydrogen is generated without electrolysis.

The hydrogen is further passed for further processing according to the method of the invention.

The metal, after being “used” as described above is reprocessed (reduced).

With the hydrogen the CO₂ is reduced to CO (the CO₂ is already very hot) and this is then, via synthesis gas, according to known methods converted to carbon-containing products selected from the group comprising or consisting of gasoline, diesel, kerosene and methane, preferably of hydrocarbons.

The hydrogen thus reduced, for example, the CO₂ from the exhaust gas, from the air or from another source, including from mixtures (HCO₃, coal, other) to form CO; said CO is according to the rules of organic chemistry, see also, but not only, the steps in the coal hydrogenation (since a long time state of the art), processed to a synthesis gas and then to the desired product, for example, fuels such as gasoline, diesel, kerosene, other products.

On the basis of the above-described cost-effective energy sources, the method is very profitable.

In the case of geothermal bores of: ordering from the manufacturer of the turbine/of the power plant as a desired auxiliary device for cooling of the steam and/or increasing the efficiency (heat exchanger/heat pumps, for example from suppliers) and (catalysts, etc) from suppliers of the power station manufacturer from the area “chemical reactors”, or specifically prepared “elements having a large surface area”, for example for the catalytic reaction(s).

In nuclear power stations: as well.

In the region of mobile power station installation locations (drilling platforms, ships' engines, etc): from the manufacturer of the power station.

Large ship engines often have an “upstream” treatment plant for the propellant. Now, they can also have a “downstream” plant for the treatment of the exhaust gas. Instead of increasing the costs the profitability is increased through recovering a part (!) of the energy in the exhaust gas as fuel.

In the case of other power plants: from case to case, according to the type of power plant.

The system according to the invention is an supplementary system, i.e. it will be added to existing power stations or to geothermal energy sources.

The above-mentioned circular process is, as well as in the exhaust gas catalyst in cars, driven from the energy.

It is therefore called a circular process (optionally catalytically).

The above hydrogen formation at high temperatures can be carried out with other suitable materials as well, if they can be reprocessed in a circular process.

Such as in the exemplary embodiment shown, the formation of hydrogen operates in the process of the invention without electrolysis with zirkalloy-alloy, that is to say the material of the fuel rods of a nuclear power plant (such as for example those of the exploded nuclear power plant in Fukushima). This method according to the invention can therefore also be called “Fukushima method”.

The metals for hydrogen formation can be used together with further substances, optionally together with “impurities” in which the the hydrogen formation operates.

In Fukushima this for example had been further metals but also substances, for example from the sea water, organic substances (microbiota in sea water), parts of the filling of the fuel rods, etc, which had been involved in the melting of the reactor core to form a mass (“corium” in the literature for short).

Other hydrogen-generating materials are covered from the patent-text as well, also “classical catalysts”, also expensive precious metals (such as platinum, etc), if they are used for the purpose of the invention, and if the hydrogen-formation happens at high temperatures without or substantially without electrolysis.

Example of an embodiment:

The metal used is a rod of zirkalloy. This material was obtained as casing as in the case of thermal (for example water-cooled) nuclear reactors (but without the uranium/plutonium/mixed oxide, with which it can be filled) and without the protection, that impeded the hydrogen-formation until the damage of the protection occurred.

Alternatively purchased zirkalloy, as a granulate, powder, etc can be used.

The zirkalloy-bar is heated through locating one side of the bar in the hot exhaust gas stream of chimneys of a power station. Through heat conducting the entire rod heated.

The part of the hot zirkalloy-rod that is outside the chimney, is flown around by water steam at about 850° C.

In this case, is hydrogen formed at the hot zirkalloy-rod. The zirkalloy-rod is completely or in part oxidized.

The zirkalloy-rod (alternatively, several rods are used) is surrounded by a container so water steam/hydrogen can be controlled.

The formed H₂ has been allowed to react with the hot supplied CO₂ from the exhaust gas of a power plant (wherein, if appropriate, also CO, HCO₃ etc from the exhaust gas of a power plant can occur) (alternatively the CO₂ from the other in the description said sources is used).

In this case, resulted after the reaction (water gas-equilibrium):

CO₂+H₂→CO+H₂O (delta H=41.2 kJ/mol)

Carbon monoxide (CO). The CO has been according to methods known to those skilled in the art processed further to carbon-containing products.

The rod originally from zirkalloy (material of the fuel rods) has been after the formation of hydrogen removed from the process. This “used” bar contains in particular oxidized zirconium and has been reprocessed as follows, to recover the zirconium for the zircalloy: to this end, the rod is cooked in a sodium hydroxide melt (alkaline digestion). The resulting zirconium dioxide has been thereafter with coke in the electrical arc converted to zirconium carbonitride (carbon and nitrogen-containing zirconium) and then with chlorine converted to zirconium tetrachloride.

ZrO₂+2C+2C₁₂ at 900° C.→ZrCl₁₄+2CO

The zirconium tetrachloride has been reduced in the so-called Kroll process with magnesium in a helium atmosphere to zirconium metal.

ZrCl₄+2Mg→Zr+2MgCl₂

As an energy source served in this case, the “for free” energy of the power chimneys or the geothermal and other suitable energy sources.

The method requires, without doubt, energy.

The method of the invention converts existing (“for free” or cheap) energy into high priced “transportable” carbon-containing products selected from the group comprising or consisting of gasoline, diesel, kerosene and methane.

What is claimed is:

1. Device for the production of generally fuels (that is carbon-containing products, such as for example, but not only, gasoline, diesel, kerosene and other, but alcohol only, nitrogen-containing products), characterised in that it produces the products exclusively, predominantly or to a large part, from steam of a power plant (applies in meaning to other devices, for example, but not limited to, steam piston machines) or from geothermal steam (applies in meaning to volcanoes, etc) and from CO₂ of the air (exclusively, predominantly or to a large part) and/or the CO₂ of the waste gas of a power station that is exclusively or predominantly or to a large part-operated with fossil fuels and/or CO₂ from other sources (volcano, delivered CO₂ or other) at appropriate temperatures without or substantially without electrolysis.

2. (canceled)

3. The device according to claim 1, splits hot steam without or substantially without electrolysis into hydrogen and oxygen such, that the water steam passes through suitable substances (including flows through, for example through granulate), for example, but not only, of Zr, zircalloy, material of nuclear fuel rods, palladium, rhodium, platinum, other substances, wherein the appropriate substances are also characterized in, that they can be recycled in a cycle back into the initial state prior to the hydrogen-generation, the appropriate substances also include “general” catalysts (materials, in which the reaction, as a rule, but not only improves temperature-dependent, or “just starts”) or “other” economic reactions the hydrogen reduces the CO₂, including mixture (CO₂, HCO₃, other) to form CO, this is according to the rules of organic chemistry, see also, but not only, the steps in the coal hydrogenation, processed to a synthesis gas and then to the intended product.

4-9. (canceled)

10. The device according to claim 1, characterized in that the system has one or more heat pumps and/or heat exchangers that serves
a) that entirely or predominantly operate as auxiliary device for cooling and/or heating of the steam, and/or
b) serves to heat the CO₂-containing exhaust gas to higher temperatures.

11. The device according to claim 1 produces alcohol with the use of the path “hydrogen”—“synthesis gas”—“circular process”—“hot steam and CO₂”.

12. The device according to claim 1, waste heat by the path to products is made, for example additional installations to steel works, marine engines, foundries and other.

13. The device according to claim 1, which receive the hydrogen from other sources, for example, but not only, the “gasifier” of steam and gas turbine power stations, reforming, etc and, in connection with power stations, including geothermal sites, produce fuels with the heat of the power plants and in the rule hot CO₂ of the power stations.
